(19) United States
(12) Patent Application Publication
(10) Pub. No.: US 2026/0351851 A1
(43) Pub. Date: Nov. 5, 2026

(54) ANTENNA MODULE AND COMMUNICATION DEVICE EQUIPPED THEREWITH

(71) Applicant: Murata Manufacturing Co., Ltd., Nagaokakyo-shi (JP)

(72) Inventors: Kenji TAHARA, Nagaokakyo-shi (JP); Kae YAMAMOTO, Nagaokakyo-shi (JP)

(73) Assignee: Murata Manufacturing Co., Ltd., Nagaokakyo-shi (JP)

(21) Appl. No.: 19/714,647

(22) Filed: Jun. 22, 2026

Related U.S. Application Data
(63) Continuation of application No. PCT/JP2025/003732, filed on Feb. 5, 2025.

(30) Foreign Application Priority Data
Mar. 5, 2024 (JP) 2024-032747

(51) Int. Cl. H01Q 3/38; H01Q 1/22

(52) U.S. Cl. CPC H01Q 3/385; H01Q 1/22

(57) ABSTRACT

An antenna module includes multiple radiating elements and multiple transmission circuits. Each radiating element has a first feed point and a second feed point at positions offset in mutually opposite directions from the center of the radiating element. Each transmission circuit includes a phase shift circuit and an amplification circuit. The amplification circuit an amplification stage, a first hybrid coupler including four connected in a ring configuration, three switches respectively connected between connection nodes of the hybrid coupler and a ground potential, and first and second phase shift lines connecting output nodes of the hybrid coupler to the first and second feed points. A signal from the amplification stage is supplied to a fourth connection node between the first line and the third line.

### CROSS-REFERENCE TO RELATED APPLICATIONS

This application is a continuation of International Application No. PCT/JP2025/003732, filed Feb. 5, 2025, which claims the benefit of Japanese Patent Application No. 2024-032747, filed Mar. 5, 2024, the contents of each of which are incorporated herein by reference in their entireties.

### TECHNICAL FIELD

The present disclosure relates to an antenna module and a communication device equipped therewith, and more particularly to a phase adjustment circuit for beamforming in an array antenna.

### BACKGROUND ART

As disclosed in International Publication No. WO 2023/210118 (Patent Document 1), an array antenna in which multiple radiating elements are arranged in a linear or planar shape is known. In such an array antenna, beamforming, in which the directivity of the radiated radio waves is changed by adjusting the phase of radio frequency (RF) signals supplied to the individual radiating elements, may be performed.

### CITATION LIST

### Patent Document

Patent Document 1: International Publication No. WO 2023/210118

### SUMMARY

An antenna module according to the present disclosure includes a plurality of radiating elements having a planar shape and a plurality of transmission circuits respectively connected to the plurality of radiating elements. Each of the plurality of radiating elements includes at least a first feed point and a second feed point disposed at positions offset from a center of the radiating element in mutually opposite directions along a first direction. Each of the plurality of transmission circuits includes a phase shift circuit configured to be capable of changing a phase of a radio frequency (RF) signal, and at least one amplification circuit. The at least one amplification circuit includes an amplification stage that amplifies a signal from the phase shift circuit, a first hybrid coupler including a first line, a second line, a third line, and a fourth line connected in a ring configuration, a first switch connected between a first connection node between the first line and the second line and a ground potential, a second switch connected between a second connection node between the second line and the fourth line and the ground potential, a third switch connected between a third connection node between the third line and the fourth line and the ground potential, a first phase shift line having a first end connected to the third connection node and a second end connected to one of the feed points of the corresponding radiating element, and a second phase shift line having a first end connected to the second connection node and a second end connected to another of the feed points of the corresponding radiating element. A signal from the amplification stage is supplied to a fourth connection node between the first line and the third line.

An antenna module according to a first aspect of the present disclosure includes multiple radiating elements having a planar shape, and multiple transmission circuits respectively connected to the multiple radiating elements, and radio waves are emitted from the multiple radiating elements. Each of the multiple radiating elements includes a first feed point and a second feed point disposed at positions offset from center of the radiating element in mutually opposite directions along a first direction. Each of the multiple transmission circuits includes a phase shift circuit configured to be capable of changing phase of a radio frequency (RF) signal, and an amplification circuit that amplifies a signal from the phase shift circuit. The amplification circuit amplifies a signal from the phase shift circuit and transmits the amplified signal to the first feed point and the second feed point of the corresponding radiating element. The amplification circuit includes an amplification stage, a first hybrid coupler, first to third switches, a first phase shift line, and a second phase shift line. The first hybrid coupler includes first to fourth lines connected in a ring configuration. The first switch is connected between a first connection node between the first line and the second line and a ground potential. The second switch is connected between a second connection node between the second line and the fourth line and the ground potential. The third switch is connected between a third connection node between the third line and the fourth line and the ground potential. The first phase shift line is connected between the third connection node and the first feed point. The second phase shift line is connected between the second connection node and the second feed point. A signal from the amplification stage is supplied to a fourth connection node between the first line and the third line.

An antenna module according to a second aspect of the present disclosure includes multiple radiating elements having a planar shape, and multiple transmission circuits respectively connected to the multiple radiating elements, and radio waves are emitted from the multiple radiating elements. Each of the multiple radiating elements has first to fourth feed points. In each radiating element, the first feed point and the second feed point are disposed at positions offset from center of the radiating element in mutually opposite directions along a first direction. In each radiating element, the third feed point and the fourth feed point are disposed at positions offset from the center of the radiating element in mutually opposite directions along a second direction intersecting the first direction. Each of the multiple transmission circuits includes a phase shift circuit, a branch circuit, a first amplification circuit, and a second amplification circuit. The phase shift circuit is configured to be capable of changing phase of a radio frequency (RF) signal. The branch circuit divides a signal from the phase shift circuit into two paths. The first amplification circuit and the second amplification circuit amplify signals from the branch circuit and transmit the amplified signals to the corresponding radiating element. Each of the first amplification circuit and the second amplification circuit includes an amplification stage that amplifies a signal from the phase shift circuit, a first hybrid coupler, first to third switches, a first phase shift line, and a second phase shift line. The first hybrid coupler includes first to fourth lines connected in a ring configuration. The first switch is connected between a first connection node between the first line and the second line and a ground potential. The second switch is connected between a second connection node between the second line and the fourth line and the ground potential. The third switch is connected between a third connection node between the third line and the fourth line and the ground potential. A first end of the first phase shift line is connected to the third connection node. A first end of the second phase shift line is connected to the second connection node. In each amplification circuit, a signal from the amplification stage is supplied to a fourth connection node between the first line and the third line. A second end of the first phase shift line of the first amplification circuit is connected to the first feed point. A second end of the second phase shift line of the first amplification circuit is connected to the second feed point. A second end of the first phase shift line of the second amplification circuit is connected to the third feed point. A second end of the second phase shift line of the second amplification circuit is connected to the fourth feed point.

In the antenna module according to the present disclosure, a hybrid coupler is disposed at a stage subsequent to the amplification stage, and RF signals are respectively supplied from two output terminals (second connection node and third connection node) of the hybrid coupler to two feed points of the radiating element disposed at positions symmetrical with respect to the center. A signal from the amplification stage is supplied to a fourth connection node (between the first line and the third line) of the hybrid coupler, which serves as the signal input end. Switches are provided between the first connection node (a second input end of the hybrid coupler), the second connection node, and the third connection node and the two output ends of the hybrid coupler and the ground potential. In such a configuration, the phase of an RF signal supplied to the radiating element can be changed by switching the output end from which an RF signal is output through switching of the switches. At this time, since the switches are not connected in series with the signal path, no losses occur due to switching of the switches. Accordingly, in the array antenna, it is possible to provide a phase adjustment circuit capable of reducing losses during beamforming.

### BRIEF DESCRIPTION OF DRAWINGS

FIG. 1 is a schematic configuration diagram of a communication device to which an antenna module according to Embodiment 1 is applied.

FIG. 2 is a diagram illustrating a detailed configuration of a transmission circuit in FIG. 1.

FIG. 3 is a diagram for describing variations of signal combining in an amplification stage.

FIG. 4 is a diagram illustrating the relationship between output power and efficiency associated with switching of amplifiers in the amplification stage in the case of series combining.

FIG. 5 is a diagram illustrating a first configuration of an output stage when radiating V-polarization.

FIG. 6 is a diagram illustrating a second configuration of the output stage when radiating V-polarization.

FIG. 7 is a diagram illustrating a first configuration of the output stage when radiating H-polarization.

FIG. 8 is a diagram illustrating a second configuration of the output stage when radiating H-polarization.

FIG. 9 is a diagram illustrating a first configuration of the output stage when radiating circular polarization.

FIG. 10 is a diagram illustrating a second configuration of the output stage when radiating circular polarization.

FIG. 11 is a first diagram for describing the influence of load variations at the time of maximum power output in the case of parallel combining.

FIG. 12 is a first diagram for describing the influence of load variations at the time of back-off in the case of parallel combining.

FIG. 13 is a second diagram for describing the influence of load variations at the time of maximum power output in the case of parallel combining.

FIG. 14 is a second diagram for describing the influence of load variations at the time of back-off in the case of parallel combining.

FIG. 15 is a first diagram for describing the influence of load variations at the time of maximum power output in the case of series combining.

FIG. 16 is a first diagram for describing the influence of load variations at the time of back-off in the case of series combining.

FIG. 17 is a second diagram for describing the influence of load variations at the time of maximum power output in the case of series combining.

FIG. 18 is a second diagram for describing the influence of load variations at the time of back-off in the case of series combining.

FIG. 19 is a diagram illustrating a detailed configuration of the transmission circuit according to Embodiment 2.

FIG. 20 is a diagram illustrating a detailed configuration of the transmission circuit according to Embodiment 3.

### DESCRIPTION OF EMBODIMENTS

Hereinafter, embodiments of the present disclosure will be described in detail with reference to the drawings. Note that the same reference numerals are assigned to identical or corresponding portions, and descriptions thereof will not be repeated.

When performing beamforming, as a phase shifter that adjusts the phase of RF signals supplied to the individual radiating elements, for example, a configuration may be employed in which multiple LC circuits for phase adjustment connected in series are selectively bypassed by semiconductor switches. Recently, in wireless communication devices, development of communication in a so-called sub-terahertz frequency band exceeding 100 GHz has been progressing for the purpose of achieving large-capacity and high-speed communication. Signals in such a sub-terahertz frequency band tend to suffer greater loss in signal paths compared with signals in the millimeter-wave band and lower frequency bands. The inventors have recognized that, when a phase shifter having switches arranged in series along the signal path as described above is used, there is a possibility that desired characteristics are not achieved due to losses in the switches.

The present disclosure has been made in view of the above-described and other problems, and is directed to providing a phase adjustment circuit capable of reducing losses during beamforming in an array antenna.

### Embodiment 1

### Overall Configuration of Communication Device

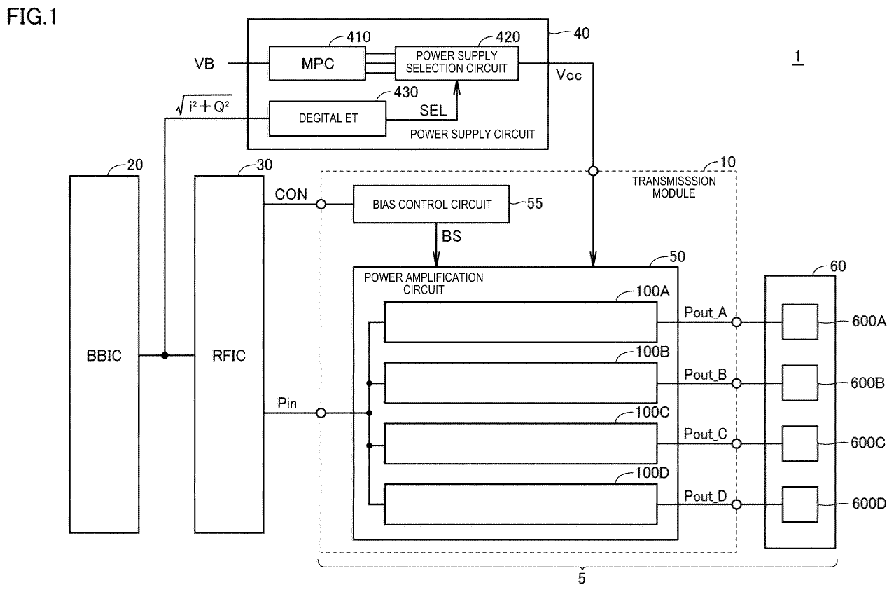

FIG. 1 is a schematic configuration diagram of a communication device 1 to which an antenna module 5 according to an embodiment is applied. The communication device 1 is, for example, a mobile terminal such as a mobile phone, a smartphone, or a tablet, or a personal computer equipped with a communication function.

Referring to FIG. 1, the communication device 1 includes a transmission module 10, a BBIC (Baseband Integrated Circuit) 20 configuring a baseband signal processing circuit, an RFIC (Radio Frequency Integrated Circuit) 30, a power supply circuit 40, and an antenna 60. The transmission module 10 includes a power amplification circuit 50 and a bias control circuit 55. Schematically, the communication device 1 upconverts an intermediate frequency (IF) signal transmitted from the BBIC 20 into a radio frequency (RF) signal by the RFIC 30, amplifies the RF signal by the power amplification circuit 50, and radiates the amplified RF signal from the antenna 60. The transmission module 10 and the antenna 60 constitute the antenna module 5 of the present disclosure. The functionality of the processing elements disclosed herein (including the BBIC 20, RFIC 30, and digital ET 430) may be implemented using circuitry or processing circuitry which includes general purpose processors, special purpose processors, integrated circuits, ASICs (‘Application Specific Integrated Circuits’), FPGAs (‘Field Programmable Gate Arrays’), conventional circuitry and/or combinations thereof.

The antenna 60 is an array antenna in which multiple radiating elements having a planar shape are arranged. In the example illustrated in FIG. 1, four radiating elements 600A to 600D having a substantially rectangular shape are arranged in a row on a substrate. Note that the shape of the radiating elements is not limited to a rectangular shape, and it may be, for example, a circular, elliptical, or other polygonal shapes. Additionally, the number of radiating elements is not limited to four. Furthermore, the radiating elements may be arranged in a two-dimensional array.

The RFIC 30 is an example of a signal processing circuit that processes RF signals. The RFIC 30 upconverts an intermediate frequency signal transmitted from the BBIC 20 into an RF signal, and outputs the generated RF signal to the transmission module 10.

The bias control circuit 55 receives a control signal CON from the RFIC 30. Based on the control signal CON, the bias control circuit 55 generates a bias signal BS for controlling the magnitude and supply timing of a bias current for amplifiers included in the power amplification circuit 50, and outputs the bias signal BS to the power amplification circuit 50. As described herein, the high-level management and logical operation of the phase shifting and switch routing may be orchestrated by a controller functionality distributed across the signal processing architecture. In some embodiments, this controller functionality is realized cooperatively via the RFIC 30 executing macro-level configuration routines and the localized bias control circuit 55 executing micro-level switch routing logic. Alternatively, a dedicated control circuit, e.g., as a microcontroller unit (MCU), a central processing unit (CPU), an application-specific integrated circuit (ASIC), or a field-programmable gate array (FPGA)—may be structurally embedded within either the RFIC 30 or the bias control circuit 55. This controller component processes directional beam-steering matrices and translates them into explicit electrical state control commands, selectively driving the first switch, second switch, third switch, and fourth switch between their respective conducting and non-conducting isolation states.

The power amplification circuit 50 amplifies an input signal Pin received from the RFIC 30 to generate output signals Pout_A to Pout_D to be output to the antenna 60. The power amplification circuit 50 includes transmission circuits 100A to 100D corresponding to the radiating elements 600A to 600D. Each transmission circuit amplifies the input signal Pin, changes the phase of the input signal Pin, and transmits the output signal to the corresponding radiating element in the antenna 60. By transmitting signals with a predetermined phase difference with respect to the adjacent radiating elements, the directivity of radio waves radiated from the array antenna can be adjusted.

Note that, in the following description, the radiating elements 600A to 600D are also collectively referred to as a “radiating element 600”, and the transmission circuits 100A to 100D are also collectively referred to as a “transmission circuit 100”.

The power supply circuit 40 is an example of a so-called digital tracker and is capable of supplying power supply voltages Vcc at different voltage levels to the power amplification circuit 50. The power supply circuit 40 includes a multilevel power converter (MPC) 410, a power supply selection circuit 420, and a digital envelope tracker (digital ET) 430.

The MPC 410 includes multiple DC/DC converters. The MPC 410 converts a battery voltage VB supplied from an external battery into multiple different voltage levels, and supply these voltage levels to the power supply selection circuit 420.

The digital ET 430 receives I-and Q-waveform signals of a transmission signal from the BBIC 20 and tracks the envelope of the transmission signal in a digital ET mode. The digital ET 430 generates a selection signal SEL corresponding to the voltage level of the envelope of the transmission signal and outputs the selection signal SEL to the power supply selection circuit 420.

The power supply selection circuit 420 selects a voltage corresponding to the selection signal SEL from among the voltage levels supplied from the MPC 410, and supplies the selected voltage as a power supply voltage Vcc to the power amplification circuit 50.

### Detailed Configuration of Transmission Circuit

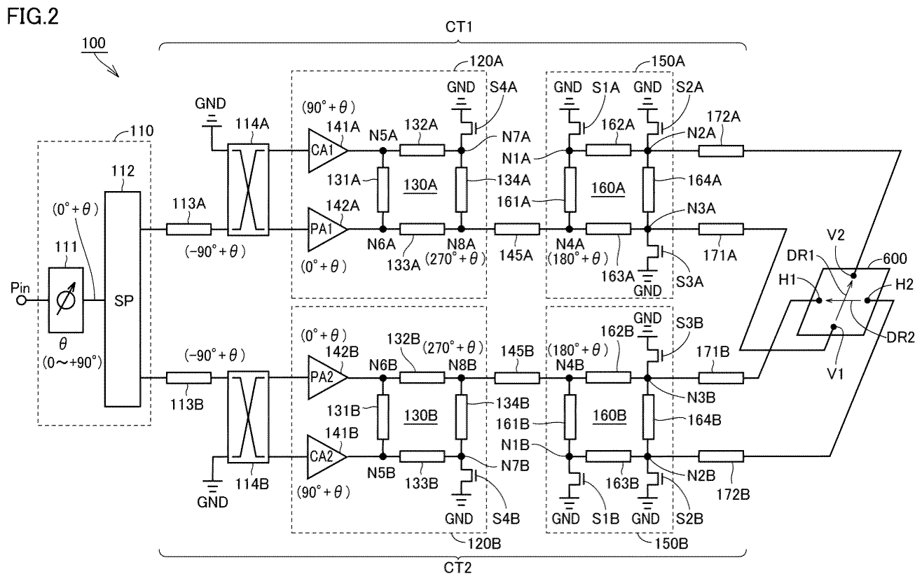

Next, a detailed configuration of the transmission circuit 100 in the power amplification circuit 50 will be described using FIG. 2.

The transmission circuit 100 includes a phase shift circuit 110, and amplification circuits CT1 and CT2. The phase shift circuit 110 includes a phase shifter 111 and a branch circuit 112. The amplification circuit CT1 includes phase shift lines 113A, 145A, 171A, and 172A, a hybrid coupler 114A, an amplification stage 120A, and an output stage 150A. Similarly, the amplification circuit CT2 includes phase shift lines 113B, 145B, 171B, and 172B, a hybrid coupler 114B, an amplification stage 120B, and an output stage 150B.

The phase shifter 111 advances the input signal Pin from the RFIC 30 by a predetermined phase shift amount θ and outputs the signal to the branch circuit 112. The phase shift amount θ set in the phase shifter 111 is set to a value between 0° and 90°. The phase shift amount θ corresponds to the steering angle of the beamforming in the antenna 60, as will be described later.

The branch circuit 112 divides the signal having passed through the phase shifter 111 into two paths and supplies the divided signals to the amplification circuits CT1 and CT2, respectively.

Next, a detailed configuration of the amplification circuits CT1 and CT2 will be described. Since the amplification circuit CT1 and the amplification circuit CT2 basically have the same configuration, the configuration of the amplification circuit CT1 will be described in detail, and for the amplification circuit CT2, only the corresponding relationship with the elements of the amplification circuit CT1 and the points different from the amplification circuit CT1 will be described.

The amplification stage 120A in the amplification circuit CT1 includes a carrier amplifier 141A, a peak amplifier 142A, a hybrid coupler 130A, and a switch S4A. The output stage 150A in the amplification circuit CT1 includes a hybrid coupler 160A and switches S1A, S2A, and S3A.

A signal supplied from the branch circuit 112 to the amplification circuit CT1 is supplied to the hybrid coupler 114A via the phase shift line 113A. The hybrid coupler 114A has two input terminals and two output terminals. The phase shift line 113A is connected to one input terminal, and the other input terminal is connected to ground potential GND. The carrier amplifier 141A is connected to one output terminal of the hybrid coupler 114A, and the peak amplifier 142A is connected to the other output terminal.

The hybrid coupler 130A includes lines 131A to 134A connected in a ring configuration. An output end of the carrier amplifier 141A is connected to a connection node N5A between the line 131A and the line 132A. An output end of the peak amplifier 142A is connected to a connection node N6A between the line 131A and the line 133A. The switch S4A is connected between a connection node N7A between the line 132A and the line 134A and the ground potential GND. A connection node N8A between the line 133A and the line 134A is connected to the hybrid coupler 160A of the output stage 150A with the phase shift line 145A interposed therebetween.

The hybrid coupler 160A includes lines 161A to 164A connected in a ring configuration. The switch S1A is connected between a connection node N1A between the line 161A and the line 162A and the ground potential GND. The phase shift line 145A is connected to a connection node N4A between the line 161A and the line 163A.

The switch S2A is connected between a connection node N2A between the line 162A and the line 164A and the ground potential GND. The switch S3A is connected between a connection node N3A between the line 163A and the line 164A and the ground potential GND.

The radiating element 600 has feed points V1 and V2 at positions offset from the center of the radiating element 600 in mutually opposite directions along a direction indicated by arrow DR1 (a first direction). Additionally, the radiating element 600 has feed points H1 and H2 at positions offset from the center of the radiating element 600 in mutually opposite directions along a direction indicated by arrow DR2 (a second direction) intersecting the first direction. In the example illustrated in FIG. 2, the first direction and the second direction are orthogonal. In the following description, for convenience, the polarization of radio waves radiated from the feed points V1 and V2 will be referred to as “vertical polarization (V-polarization)”, and the polarization of radio waves radiated from the feed points H1 and H2 will be referred to as “horizontal polarization (H-polarization)”.

The connection node N3A in the hybrid coupler 160A is connected to the feed point V1 of the radiating element 600 with the phase shift line 171A interposed therebetween. The connection node N2A in the hybrid coupler 160A is connected to the feed point V2 of the radiating element 600 with the phase shift line 172A interposed therebetween.

Note that each of the lines 131A to 134A, 161A to 164A, and the phase shift lines 113A, 145A, 171A, and 172A has a line length of approximately one-quarter wavelength of the center frequency of the RF signal to be transmitted by the amplification circuit CT1. Therefore, as the RF signal passes through each of these lines, the phase of the signal is delayed by about 90°. Each of the first line, the second line, the third line, and the fourth line of the first hybrid coupler 160A, as well as the first phase shift line 145A and the second phase shift line 155A, may be physically structurally realized as microstrip lines, strip-lines, or co-planar waveguide structures fabricated on a dielectric substrate layer. For example, each of these lines may provide an electrical path length selected to be substantially equal to one-quarter wavelength (λ/4) of a target center operating frequency of the incoming RF signal, thereby establishing a predictable phase delay and predictable impedance matching network across the high-frequency operational band.

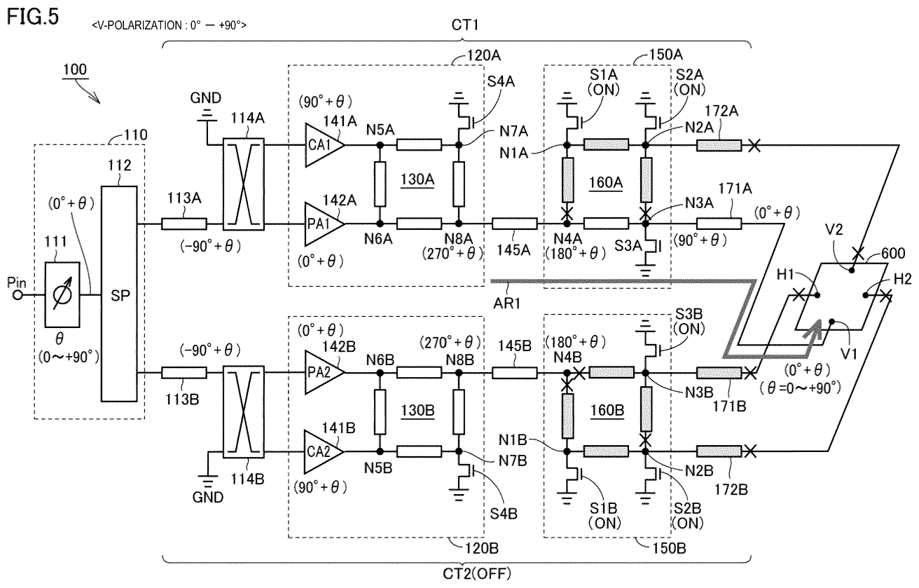

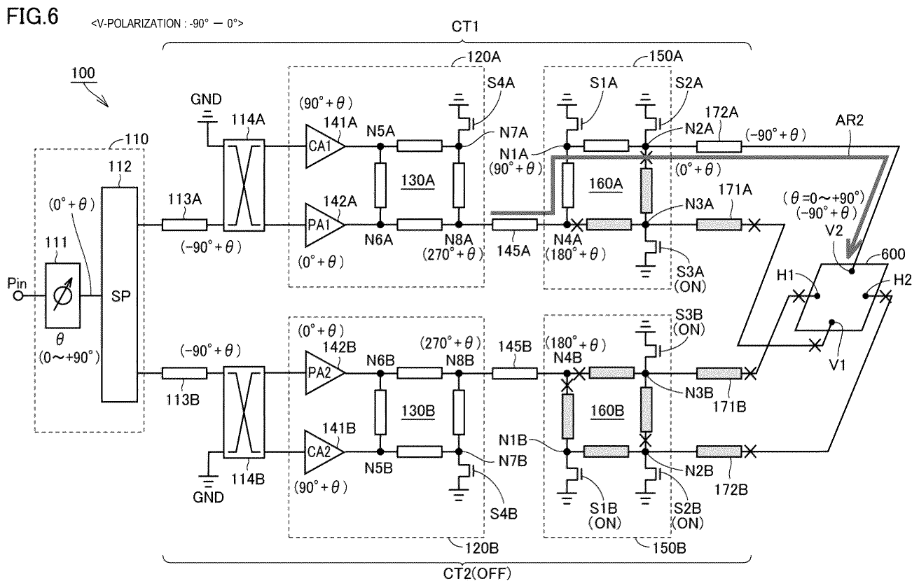

In the amplification circuit CT1, as will be described later with reference to FIGS. 5 and 6, due to the three hybrid couplers 114A, 130A, and 150A, the signal supplied to the feed point V1 of the radiating element 600 and the signal supplied to the feed point V2 have a phase difference of 90°. Furthermore, the feed point V1 and the feed point V2 are disposed at positions offset to opposite sides with respect to the center of the radiating element 600.

In such a configuration, by switching the feed position to the radiating element 600 using the switches S1A to S3A in the output stage 150A, the phase of radio waves radiated from the radiating element 600 can be changed in the positive and negative directions within the range of the phase shift amount θ of the phase shifter 111. Therefore, in the array antenna, by appropriately setting the phase shift amount of the phase shifter 111 in each radiating element, the directivity adjustment (beamforming) of V-polarization radio waves radiated from the array antenna can be performed.

In recent years, in wireless communication devices, development of communication in a so-called sub-terahertz frequency band exceeding 100 GHz has been progressing for the purpose of achieving large-capacity and high-speed communication. Signals in such a sub-terahertz frequency band tend to suffer greater loss in signal paths compared with signals in the millimeter-wave band and lower frequency bands. Therefore, when a phase shifter having switches arranged in series along the signal path is used, there is a possibility that desired characteristics are not achieved due to losses in the switches.

However, in the transmission circuit of Embodiment 1, the signal transmitted to the radiating element 600 does not pass through the switches S1A to S3A used for switching the feed position of each radiating element, and therefore no loss occurs due to switching of the switches. Accordingly, even when radio waves are radiated using a signal in the sub-terahertz frequency band, a reduction in the gain of radio waves radiated from the radiating element 600 can be suppressed.

The amplification circuit CT2 is a circuit for transmitting an RF signal for radiating horizontal polarization (H-polarization) to the radiating element 600. The amplification stage 120B in the amplification circuit CT2 includes a carrier amplifier 141B, a peak amplifier 142B, a hybrid coupler 130B, and a switch S4B. The output stage 150B in the amplification circuit CT2 includes a hybrid coupler 160B and switches S1B, S2B, and S3B. Additionally, the hybrid coupler 130B includes lines 131B to 134B connected in a ring configuration, and the hybrid coupler 160B includes lines 161B to 164B connected in a ring configuration.

The hybrid couplers 114A, 130A, and 160A in the amplification circuit CT1 correspond to the hybrid couplers 114B, 130B, and 160B in the amplification circuit CT2, respectively. The hybrid coupler 114A and the peak amplifier 142A in the amplification circuit CT1 correspond to the carrier amplifier 141B and the peak amplifier 142B in the amplification circuit CT2, respectively. The phase shift lines 113A, 145A, 171A, and 172A in the amplification circuit CT1 correspond to the phase shift lines 113B, 145B, 171B, and 172B in the amplification circuit CT2, respectively.

A connection node N3B in the hybrid coupler 160B is connected to the feed point H1 of the radiating element 600 with the phase shift line 171B interposed therebetween. A connection node N2B in the hybrid coupler 160B is connected to the feed point H2 of the radiating element 600 with the phase shift line 172B interposed therebetween.

Like the amplification circuit CT1, in the beamforming of H-polarization by the amplification circuit CT2, it is possible to suppress loss due to switching of the switches, thereby preventing gain reduction.

### Signal Combining in Amplification Stage

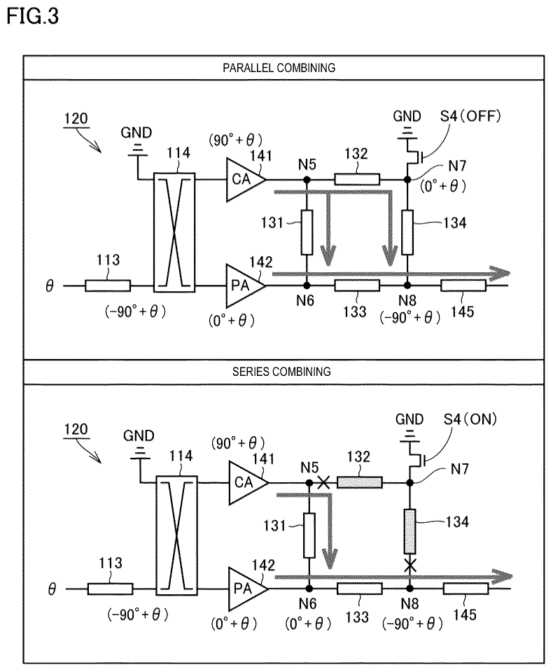

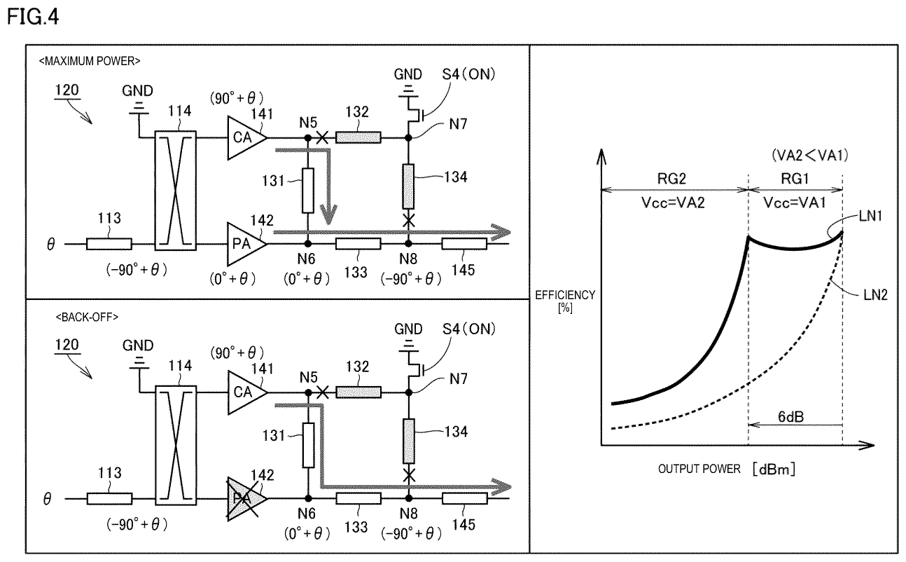

Using FIGS. 3 and 4, signal combining methods and their efficiencies in the amplification stages 120A and 120B will be described. Note that, in FIGS. 3 and 4, the reference numerals in the drawings are indicated without the suffix letters in order to collectively describe both the amplification stages 120A and 120B.

FIG. 3 is a diagram for describing variations in signal combining in the amplification stage 120. Signal combining in the amplification stage can be switched between two configurations depending on the state of the switch S4.

Specifically, when the switch S4 connected to the connection node N7 is in a non-conducting state (OFF), as indicated in the upper diagram, the output signal from the carrier amplifier 141 is combined with the output signal from the peak amplifier 142 at the connection node N8 via the lines 132 and 134, and is also combined with the output signal from the peak amplifier 142 at the connection node N6 via the line 131. In the following description, this signal combining method will be referred to as “parallel combining”.

In contrast, in the case where the switch S1 is in a conducting state (ON), as indicated in the lower diagram, the connection node N7 is short-circuited. Therefore, due to impedance transformation by the lines 132 and 134, the impedance seen from the connection node N5 toward the line 132 and the impedance seen from the connection node N8 toward the line 134 become open-circuited. As a result, the output signal from the carrier amplifier 141 does not pass through the lines 132 and 134, and is combined with the output signal from the peak amplifier 142 at the connection node N6 via the line 131. In the following description, this signal combining method will be referred to as “series combining”. In the case of series combining, the amplification stage 120 constitutes a so-called Doherty amplifier.

FIG. 4 is a diagram illustrating the relationship between output power and efficiency associated with switching of amplifiers in the amplification stage 120 in the case of series combining. In the amplification stage 120, the amplifiers to be used are switched according to the power level of the input signal Pin.

Specifically, when the power level of the input signal Pin is greater than a predetermined power level, both the carrier amplifier 141 and the peak amplifier 142 are set to an active state (upper left in FIG. 4). Meanwhile, when the power level of the input signal Pin is less than the predetermined power level, only the carrier amplifier 141 is set to an active state, and the peak amplifier 142 is set to an inactive state (lower left in FIG. 4).

The right side of FIG. 4 is a graph illustrating the relationship between output power and efficiency in the amplification stage 120. In this graph, the horizontal axis represents the power level of the output signal from the amplification stage 120, and the vertical axis represents the efficiency of the amplification stage 120. Note that solid line LN1 indicates the efficiency in the case of the amplification stage 120 of Embodiment 1, and dashed line LN2 indicates the efficiency in a case where a class-AB amplifier capable of outputting the same maximum power as the amplification stage 120 is used alone.

In the amplification stage 120, the power supply voltage Vcc from the power supply circuit 40 is switched between two levels according to the power level of the input signal Pin. In a high-output region RG1, the power supply voltage Vcc is set to VA1. In a low-output region RG2, the power supply voltage Vcc is set to VA2, which is lower than VA1 (VA1>VA2).

Since large power is required in the region RG1, both the carrier amplifier 141 and the peak amplifier 142 of the amplification stage 120 are set to an active state. In the region RG2, the peak amplifier 142 of the amplification stage 120 is set to an inactive state, and only the carrier amplifier 141 is activated.

When a class-AB amplifier is used, the efficiency reaches its maximum when the output power is the maximum power, and the efficiency gradually decreases as the output power decreases (dashed line LN2). Meanwhile, in the amplification stage 120 of Embodiment 1, in the region RG1, the parallel operation of the carrier amplifier 141 and the peak amplifier 142 improves the efficiency as compared with the case of the class-AB amplifier.

In contrast, in the region RG2, the load impedance of the carrier amplifier 141 increases as the peak amplifier 142 is stopped. As a result, the efficiency of the carrier amplifier 141 is increased, thereby achieving a back-off amount of 6 dB (solid line LN1).

Even when the amplification stage 120 employs parallel combining, by setting the peak amplifier 142 to an inactive state in the low-output region RG2, the number of amplifiers is reduced by half and the load impedance increases as compared with the operating state in the region RG1, thereby making it possible to achieve a back-off amount of 6 dB.

### Setting of Output Stage and Polarization Direction

### (1) Linear Polarization

Next, using FIGS. 5 to 8, configurations of the output stages 150A and 150B in the case of a transmission circuit corresponding to a so-called dual-band type antenna that radiates two different linearly polarized radio waves from the radiating element 600 will be described.

### (a) V-Polarization

FIGS. 5 and 6 are diagrams illustrating configurations of the output stage when radiating V-polarization. In this case, an RF signal is supplied from the amplification circuit CT1 to the radiating element 600 and not from the amplification circuit CT2.

FIG. 5 illustrates a case in which an RF signal is supplied from the amplification circuit CT1 to the feed point V1 of the radiating element 600. In this case, the switches S1A and S2A of the output stage 150A of the amplification circuit CT1 are set to a conducting state, and the switch S3A is set to a non-conducting state. As a result, the connection nodes N1A and N2A are short-circuited, and therefore the impedance seen from the connection node N4A toward the line 161A and the impedance seen from the connection node N3A toward the line 164A become open-circuited. Accordingly, the RF signal supplied from the amplification stage 120A to the output stage 150A is supplied to the feed point V1 of the radiating element 600 via the line 163A and the phase shift line 171A (arrow AR1).

In this case, when the phase of the input signal Pin is 0° and the phase shift amount by the phase shifter 111 is θ, the phase of the signal at the input end of the hybrid coupler 114A is delayed by 90° by the phase shift line 113A. The hybrid coupler 114A then inputs signals with a phase difference of 90° to the carrier amplifier 141A and the peak amplifier 142A, respectively. In the present specification, it is assumed that the phase of the signal input to the carrier amplifier 141A is 90°+θ, and the phase of the signal input to the peak amplifier 142A is 0°+θ.

In the hybrid coupler 130A, the path length from the carrier amplifier 141A to the connection node N8A, which is the output end, is twice the path length from the peak amplifier 142A to the connection node N8A. Therefore, the phase of each signal at the connection node N8A becomes 270° +θ, and the signals from the two amplifiers are combined in phase at the connection node N8A.

The phase of the signal at the connection node N4A, which is the input end of the hybrid coupler 160A, becomes 180°+θ due to the phase shift line 145A. Then, because the phase is delayed by 90° by each of the line 163A and the phase shift line 171A, the phase of the signal supplied to the feed point V1 becomes 0°+θ.

Note that, in this case, the switches S1B to S3B in the output stage 150B of the amplification circuit CT2 are all set to a conducting state. As a result, the impedances seen from the connection node N4B toward the line 161B and the line 163B both become open-circuited, and therefore no RF signal is supplied from the amplification circuit CT2 to the radiating element 600.

By setting the switches of the output stages 150A and 150B as described above, and by setting the phase shift amount θ in the phase shift circuit 110 with respect to the adjacent radiating elements within the range of 0° to 90°, the steering angle in the V-polarization direction of the radio waves radiated from the array antenna can be adjusted within the range of 0° to 90°.

FIG. 6 illustrates a case in which an RF signal is supplied from the amplification circuit CT1 to the feed point V2 of the radiating element 600. In this case, the switches S1A and S2A of the output stage 150A of the amplification circuit CT1 are set to a non-conducting state, and the switch S3A is set to a conducting state. As a result, the connection node N3A is short-circuited, and therefore the impedance seen from the connection node N4A toward the line 163A and the impedance seen from the connection node N2A toward the line 164A become open-circuited. Accordingly, the RF signal supplied from the amplification stage 120A to the output stage 150A is supplied to the feed point V2 of the radiating element 600 via the lines 161A and 162A and the phase shift line 172A (arrow AR2).

In this case again, when the phase of the input signal Pin is 0° and the phase shift amount by the phase shifter 111 is θ, the phase of the signal at the connection node N4A, which is the input end of the hybrid coupler 160A, becomes 180°+θ, as in the case of FIG. 5. Then, in the hybrid coupler 160A, because the phase is delayed by 90° by each of the lines 161A and 162A and the phase shift line 172A, the phase of the signal supplied to the feed point V2 becomes −90°+θ.

Note that, in this case again, the switches S1B to S3B in the output stage 150B of the amplification circuit CT2 are all set to a conducting state.

By setting the switches of the output stages 150A and 150B as described above, and by setting the phase shift amount θ in the phase shift circuit 110 with respect to the adjacent radiating elements within the range of 0° to 90°, the steering angle in the V-polarization direction of the radio waves radiated from the array antenna can be adjusted within the range of −90° to 0°.

As described above, by setting the phase shift amount θ with respect to the adjacent radiating elements within the range of 0° to 90° using the phase shift circuit 110, and by switching the switches S1A to S3A of the output stage 150A, the steering angle of the radio waves in the V-polarization direction radiated from the array antenna can be switched to the −θ direction and the +θ direction.

### (b) H-Polarization

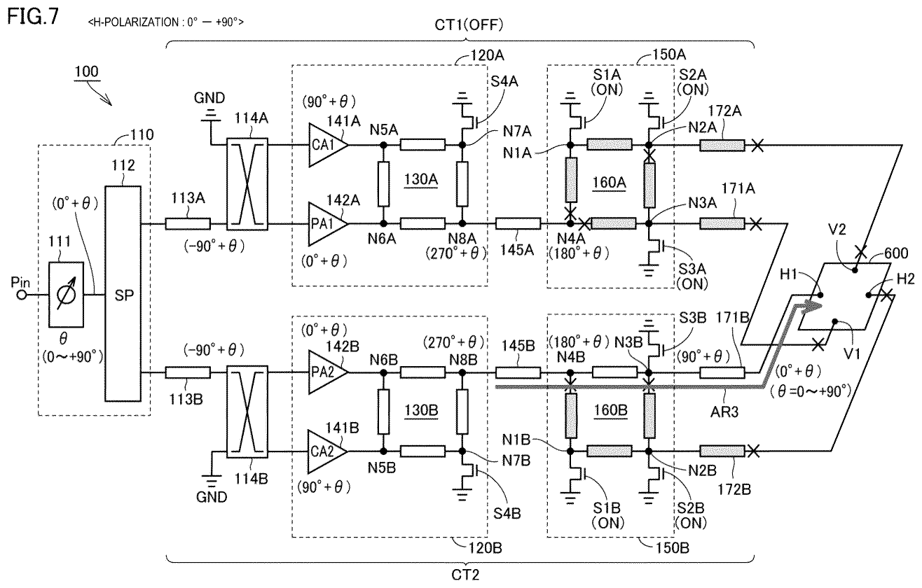

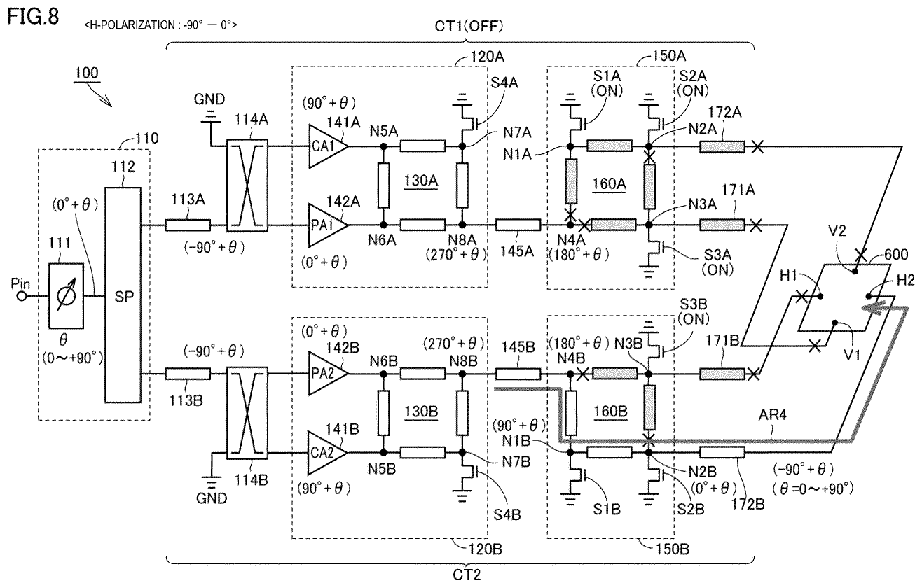

FIGS. 7 and 8 are diagrams illustrating configurations of the output stage when radiating H-polarization. In this case, an RF signal is supplied from the amplification circuit CT2 to the radiating element 600 and not from the amplification circuit CT1. Therefore, in FIGS. 7 and 8, the switches S1A to S3A in the output stage 150A of the amplification circuit CT1 are all set to a conducting state.

FIG. 7 illustrates a case in which an RF signal is supplied from the amplification circuit CT2 to the feed point H1 of the radiating element 600. In this case, the switches S1B and S2B of the output stage 150B of the amplification circuit CT2 are set to a conducting state, and the switch S3B is set to a non-conducting state. As a result, the connection nodes N1B and N2B are short-circuited, and therefore the impedance seen from the connection node N4B toward the line 161B and the impedance seen from the connection node N3B toward the line 164B become open-circuited. Accordingly, the RF signal supplied from the amplification stage 120B to the output stage 150B is supplied to the feed point H1 of the radiating element 600 via the line 163B and the phase shift line 171B (arrow AR3).

In this case, when the phase of the input signal Pin is 0° and the phase shift amount by the phase shifter 111 is θ, the phase of the signal supplied to the feed point H1 becomes 0°+θ, as in the case of FIG. 5. Accordingly, by setting the phase shift amount θ in the phase shift circuit 110 with respect to the adjacent radiating elements within the range of 0° to 90°, the steering angle in the H-polarization direction of the radio waves radiated from the array antenna can be adjusted within the range of 0° to 90°.

FIG. 8 illustrates a case in which an RF signal is supplied from the amplification circuit CT2 to the feed point H2 of the radiating element 600. In this case, the switches S1B and S2B of the output stage 150B of the amplification circuit CT2 are set to a non-conducting state, and the switch S3B is set to a conducting state. As a result, the connection node N3B is short-circuited, and therefore the impedance seen from node N4B toward the line 163B and the impedance seen from node N2B toward the line 164B become open-circuited. Accordingly, the RF signal supplied from the amplification stage 120B to the output stage 150B is supplied to the feed point H2 of the radiating element 600 via the lines 161B and 162B and the phase shift line 172B (arrow AR4).

In this case again, when the phase of the input signal Pin is 0° and the phase shift amount by the phase shifter 111 is θ, the phase of the signal supplied to the feed point H2 becomes −90°+θ, as in the case of FIG. 6. Accordingly, by setting the phase shift amount θ in the phase shift circuit 110 with respect to the adjacent radiating elements within the range of 0° to 90°, the steering angle in the H-polarization direction of the radio waves radiated from the array antenna can be adjusted within the range of −90° to 0°. By utilizing the first amplification circuit CT1 and the second amplification circuit CT2 to simultaneously supply radio frequency (RF) signals to the radiating element 10, the antenna module 100 can be dynamically configured to operate in a dual-polarization or circular-polarization mode. Specifically, when a relative phase difference of +90° or $90° is maintained between the signals delivered by the first amplification circuit CT1 and the second amplification circuit CT2 to their respective feed points, the orthogonal phase relationships synthesize a rotating electromagnetic field. This enables the radiating element 10 to selectively emit or receive either a right-hand circularly polarized wave (RHCP) or a left-hand circularly polarized wave (LHCP), depending on the targeted polarization state selected.

As described above, by setting the phase shift amount θ with respect to the adjacent radiating elements within the range of 0° to 90° using the phase shift circuit 110, and by switching the switches S1B to S3B of the output stage 150B, the steering angle of the radio waves in the V-polarization direction radiated from the array antenna can be switched to the −θ direction and the +θ direction.

### (2) Circular Polarization

Next, a case in which the radiating element 600 radiates circularly polarized radio waves will be described.

### (a) Setting of Output Stage

When circularly polarized radio waves are radiated using a patch antenna having a planar shape, RF signals having a phase difference of 90° are supplied to two feed points offset from the center of the radiating element in mutually orthogonal directions.

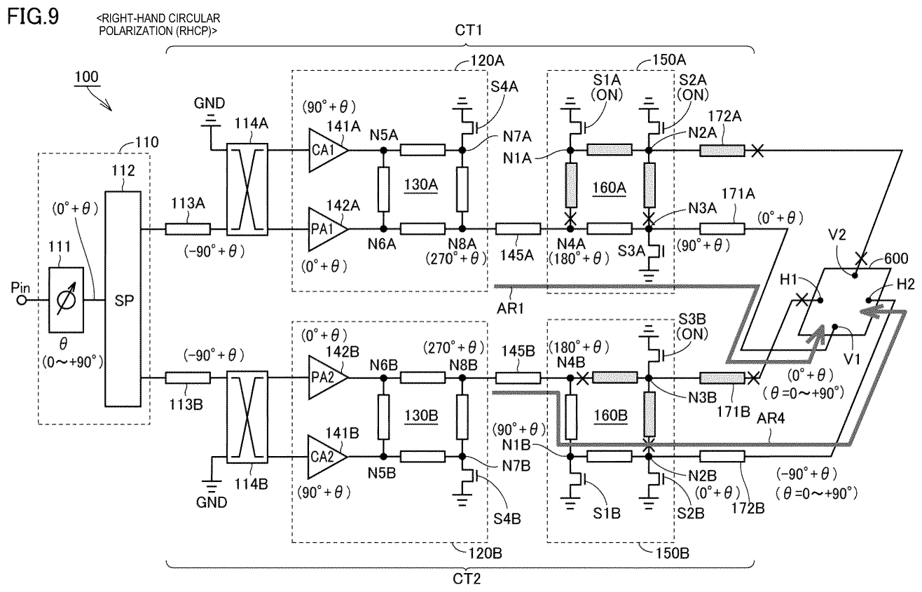

FIG. 9 illustrates the configuration of the output stage when radiating right-hand circularly polarized waves (RHCP). In this case, the radiating element 600 is supplied with an RF signal from the amplification circuit CT1 to the feed point V1 and an RF signal from the amplification circuit CT2 to the feed point H2.

When the phase shift amount in the phase shift circuit 110 is θ, as described above, the phase of the signal supplied to the feed point V1 becomes 0°+θ, and the phase of the signal supplied to the feed point H2 becomes −90°+θ. That is, RF signals having a phase difference of 90° are supplied. Since the phase of the signal supplied to the feed point H2 lags behind the signal supplied to the feed point V1, the radiating element 600 radiates right-hand circularly polarized waves (RHCP) that rotate clockwise in the direction of radiation. Furthermore, by setting the phase shift amount θ in the phase shift circuit 110 with respect to the adjacent radiating elements within the range of 0° to 90°, the steering angle of the radio waves radiated from the array antenna can be switched to the −θ direction and the +θ direction.

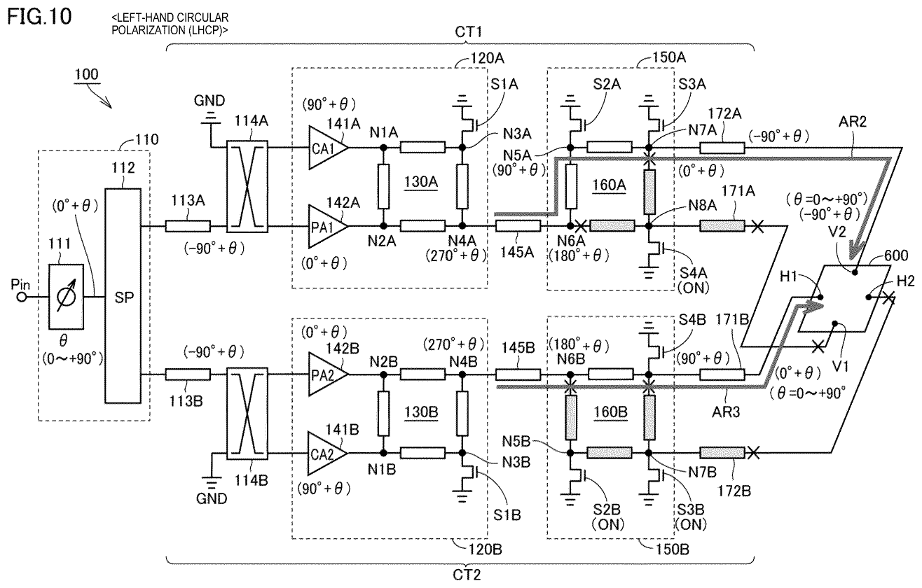

FIG. 10 illustrates the configuration of the output stage when radiating left-hand circularly polarized waves (LHCP). In this case, the radiating element 600 is supplied with an RF signal from the amplification circuit CT1 to the feed point V2 and an RF signal from the amplification circuit CT2 to the feed point H1.

When the phase shift amount in the phase shift circuit 110 is θ, as described above, the phase of the signal supplied to the feed point V2 becomes-90°+θ, and the phase of the signal supplied to the feed point H1 becomes 0°+θ. That is, RF signals having a phase difference of 90° are supplied. Since the phase of the signal supplied to the feed point V2 lags behind the signal supplied to the feed point H1, the radiating element 600 radiates left-hand circularly polarized waves (LHCP) that rotate counterclockwise in the direction of radiation. Furthermore, by setting the phase shift amount θ in the phase shift circuit 110 with respect to the adjacent radiating elements within the range of 0° to 90°, the steering angle of the radio waves radiated from the array antenna can be switched to the −θ direction and the +θ direction.

### (b) Robustness Against Load Variations

In the antenna module 5 of Embodiment 1, when circularly polarized radio waves are radiated, the effect that the robustness of the antenna against load variations is improved can be achieved.

### <Parallel Combining>

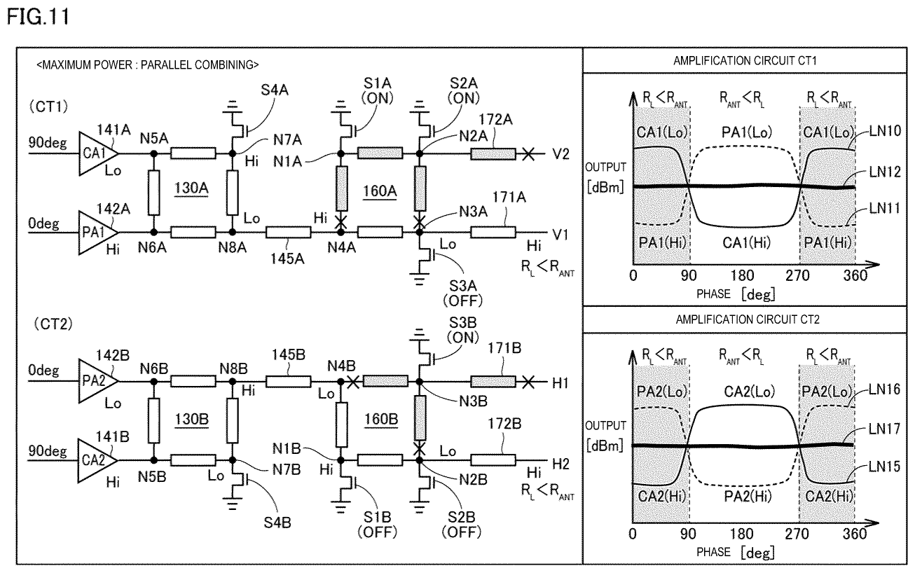

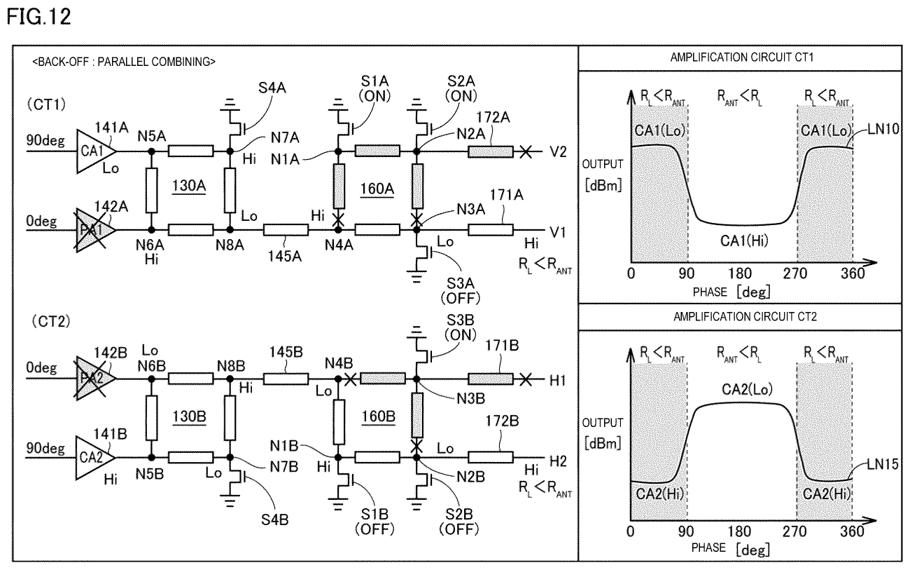

FIGS. 11 to 14 illustrate the effects of load variations when the amplification stages 120A and 120B employ parallel combining. More specifically, FIGS. 11 and 12 are diagrams for describing the output states of the individual amplifiers when a load impedance R_{ANT} of the radiating element 600 becomes larger than a characteristic impedance R_{L} (R_{L}<R_{ANT}). FIG. 11 illustrates the case at the time of maximum power output when both the carrier amplifier and the peak amplifier are activated. FIG. 12 illustrates the case at the time of back-off when the peak amplifier is set to an inactive state.

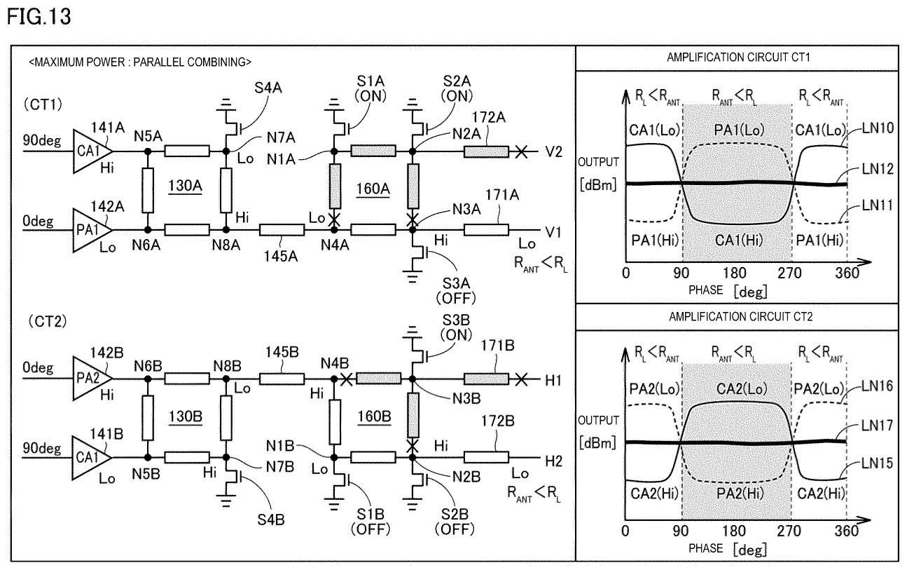

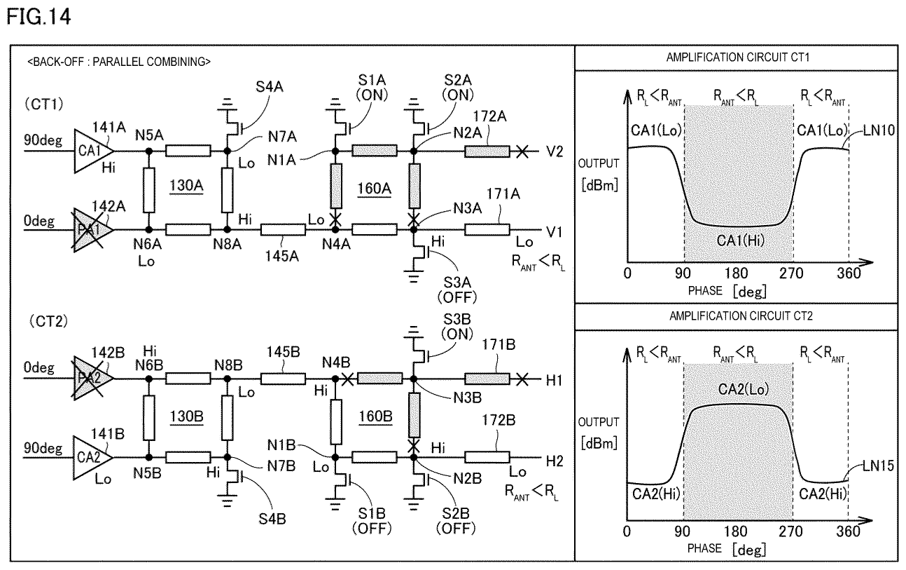

Additionally, FIGS. 13 and 14 are diagrams for describing the output states of the individual amplifiers when the load impedance R_{ANT} of the radiating element 600 becomes smaller than the characteristic impedance R_{L} (R_{ANT}<R_{L}). FIG. 13 illustrates the case at the time of maximum power output, and FIG. 14 illustrates the case at the time of back-off.

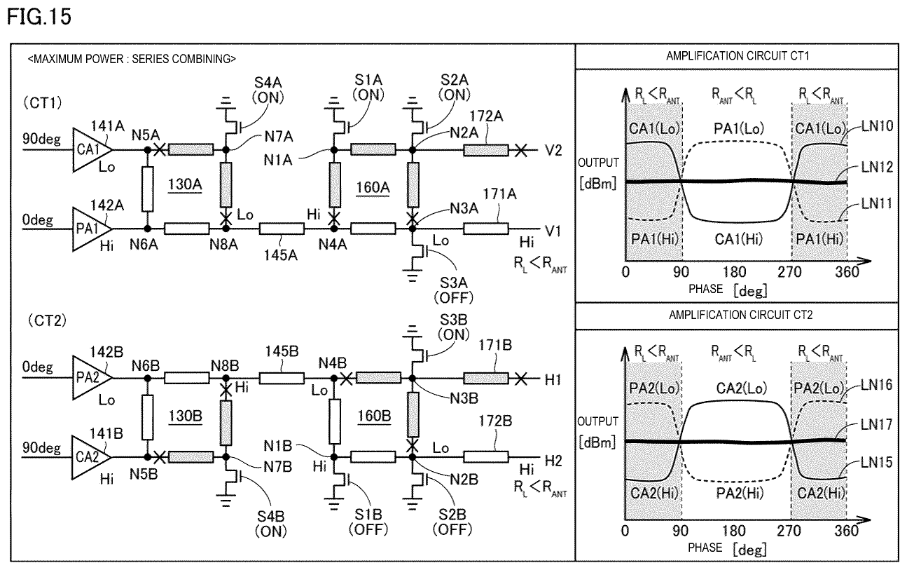

Note that, in FIGS. 11 to 14 and later-described FIGS. 15 to 18, the left side indicates the direction of load impedance variation at each point in the amplification circuits CT1 and CT2 as “Hi” or “Lo”. On the right side, the upper portion illustrates the variation in output power of each amplifier in the amplification circuit CT1, while the lower portion illustrates the variation in output power of each amplifier in the amplification circuit CT2. In the following description, the case of right-hand circularly polarized waves (RHCP) illustrated in FIG. 9 will be described by way of example.

Referring to FIG. 11, when the load impedance R_{ANT} of the radiating element 600 becomes larger than the characteristic impedance R_{L}, namely, Hi, in the amplification circuit CT1, the load impedance at the connection node N3A becomes Lo due to the phase shift line 171A. Then, the load impedance at the connection node N4A becomes Hi due to the line 163A, and the load impedance at the output end (connection node N8A) of the hybrid coupler 130A becomes Lo due to the phase shift line 145A.

Since the signal path from the connection node N8A to the carrier amplifier 141A passes through two lines (line 132A +line 134A, or line 131A +line 133A), the load impedance seen from the carrier amplifier 141A becomes Lo.

Meanwhile, since the signal path from the connection node N8A to the peak amplifier 142A passes through only one line (line 133A), the load impedance seen from the peak amplifier 142A becomes Hi.

In each amplifier, an increase in load impedance causes a decrease in output power, and a decrease in load impedance causes an increase in output power. Therefore, in the amplification circuit CT1, as in the case where the phase is 0° to 90° or 270° to 360° as illustrated in the upper graph on the right, the output power of the carrier amplifier 141A increases due to load decrease (solid line LN10). Meanwhile, the output power of the peak amplifier 142A decreases due to load increase (dashed line LN11). As a result, power variations are offset by the increase in output power of the carrier amplifier 141A and the decrease in output power of the peak amplifier 142A, so that the combined output power in the amplification circuit CT1 exhibits flat characteristics, as indicated by solid line LN12.

In the amplification circuit CT2, the load impedance at the connection node N2B becomes Lo due to the phase shift line 172B. Then, in the hybrid coupler 160B, the load impedance at the connection node N1B becomes Hi due to the line 162B, and the load impedance at the connection node N4B becomes Lo due to the line 161B. Furthermore, the load impedance at the output end (connection node N8B) of the hybrid coupler 130B becomes Hi due to the phase shift line 145B.

Since the signal path from the connection node N8B to the carrier amplifier 141B passes through two lines (line 132B+line 134B, or line 131B+line 133B), the load impedance seen from the carrier amplifier 141B becomes Hi.

Meanwhile, since the signal path from the connection node N8B to the peak amplifier 142B passes through only one line (line 133B), the load impedance seen from the peak amplifier 142B becomes Lo.

Accordingly, in the amplification circuit CT2, as indicated in the lower graph on the right, the output power of the carrier amplifier 141B decreases due to load increase (solid line LN15), while the output power of the peak amplifier 142B increases due to load decrease (dashed line LN16). As a result, power variations are offset by the decrease in output power of the carrier amplifier 141B and the increase in output power of the peak amplifier 142B, so that the combined output power in the amplification circuit CT2 exhibits flat characteristics, as indicated by solid line LN17.

That is, as a result, in each of the amplification circuits CT1 and CT2, variations in output power caused by load impedance variations are offset, and therefore the variations in output power of the entire transmission circuit are suppressed. This improves the robustness of the antenna against load variations.

At the time of back-off in FIG. 12, the peak amplifier 142A in the amplification circuit CT1 is set to an inactive state, and the peak amplifier 142B in the amplification circuit CT2 is set to an inactive state. In this case, since the load impedance seen from the carrier amplifier 141A becomes Lo in the amplification circuit CT1, the output power from the amplification circuit CT1 increases (solid line LN10). Meanwhile, since the load impedance seen from the carrier amplifier 141B becomes Hi in the amplification circuit CT2, the output power from the amplification circuit CT2 decreases (solid line LN15).

As described above, at the time of back-off, in each amplification circuit, the output power increases or decreases in response to load variations of the radiating element 600. However, since the direction of variation in output power in the amplification circuit CT1 is opposite to that in the amplification circuit CT2, variations in output power are suppressed for each transmission circuit as a whole. Accordingly, the robustness of the antenna against load variations can be improved even at the time of back-off.

Next, referring to FIG. 13, at the time of maximum power output, when the load impedance R_{ANT} of the radiating element 600 becomes smaller than the characteristic impedance R_{L}, in the amplification circuit CT1, the load impedance seen from the carrier amplifier 141A becomes Hi, while the load impedance seen from the peak amplifier 142A becomes Lo. Additionally, in the amplification circuit CT2, the load impedance seen from the carrier amplifier 141B becomes Lo, while the load impedance seen from the peak amplifier 142B becomes Hi.

As a result, as in the case where the phase is 90° to 270° in the right-hand graph of FIG. 13, in each amplification circuit, the directions of variation in output power of the carrier amplifier and the peak amplifier become opposite to each other. Therefore, variations in output power are suppressed in each amplifier, and as a result, variations in the entire transmission circuit are also suppressed. Accordingly, the robustness of the antenna against load variations can be improved.

At the time of back-off in FIG. 14, the peak amplifier 142A in the amplification circuit CT1 is set to an inactive state, and the peak amplifier 142B in the amplification circuit CT2 is set to an inactive state. In this case, since the load impedance seen from the carrier amplifier 141A becomes Hi in the amplification circuit CT1, the output power from the amplification circuit CT1 decreases. Meanwhile, since the load impedance seen from the carrier amplifier 141B becomes Lo in the amplification circuit CT2, the output power from the amplification circuit CT2 increases.

Accordingly, even at the time of back-off, when load variations of the antenna occur, variations in the output power are suppressed in the entire transmission circuit. Therefore, robustness of the antenna against load variations can be improved.

### <Series Combining>

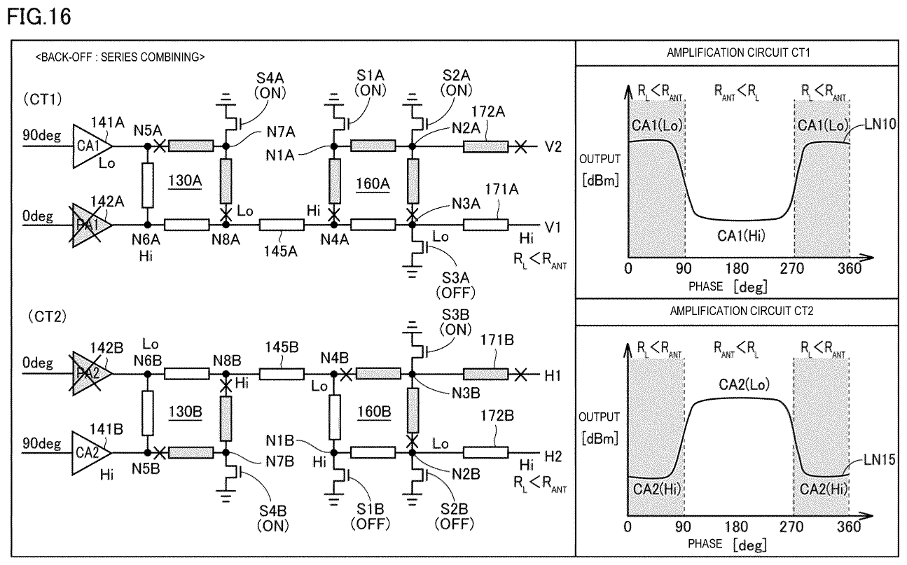

FIGS. 15 to 18 illustrate the effects of load variations when the amplification stages 120A and 120B employ series combining. More specifically, FIGS. 15 and 16 are diagrams for describing the output states of the individual amplifiers when the load impedance R_{ANT} of the radiating element 600 becomes larger than the characteristic impedance R_{L} (R_{L}<R_{ANT}). FIG. 15 illustrates the case at the time of maximum power output, and FIG. 16 illustrates the case at the time of back-off.

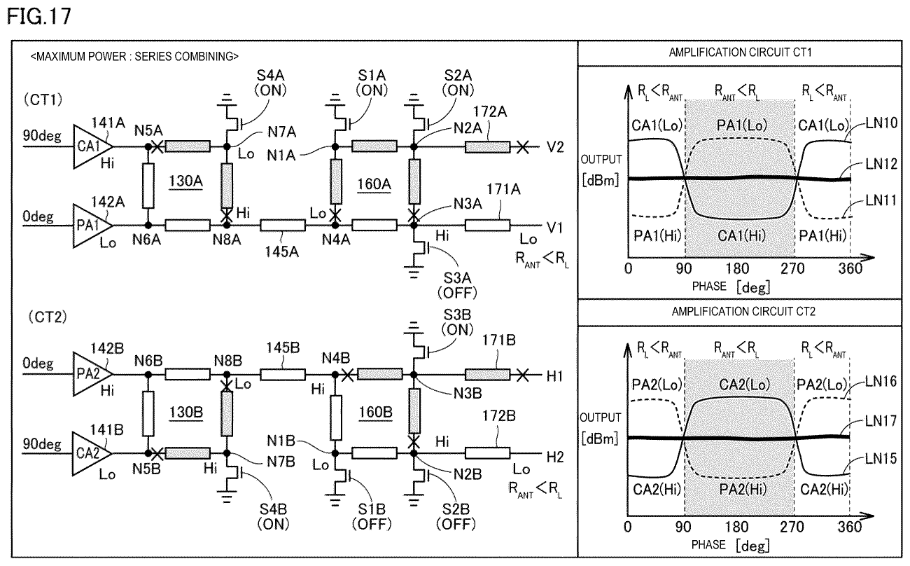

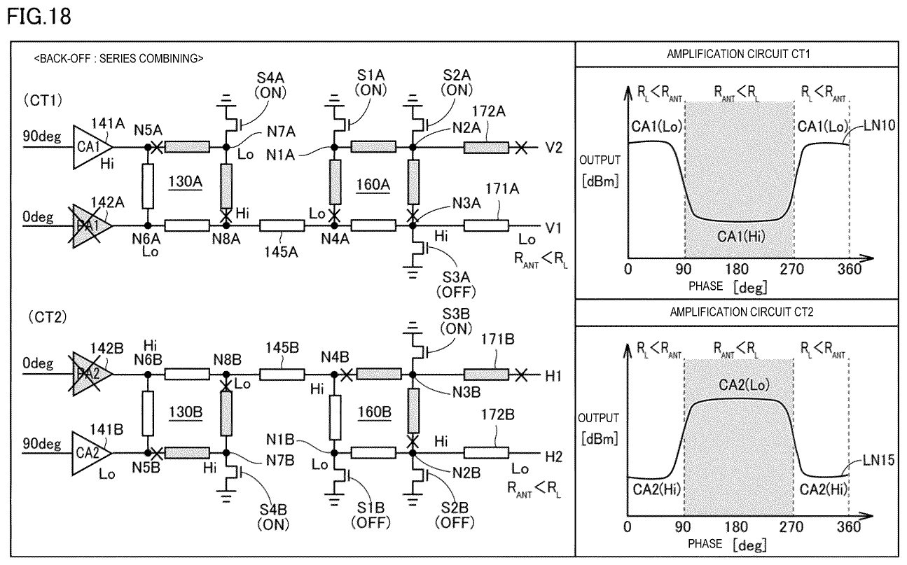

Additionally, FIGS. 17 and 18 are diagrams for describing the output states of the individual amplifiers when the load impedance R_{ANT} of the radiating element 600 becomes smaller than the characteristic impedance R_{L} (R_{ANT}<R_{L}). FIG. 17 illustrates the case at the time of maximum power output, and FIG. 18 illustrates the case at the time of back-off.

Again, in the case of series combining, as in the case of parallel combining, when the load impedance R_{ANT} of the radiating element 600 becomes larger than the characteristic impedance R_{L}, the load impedance of the carrier amplifier 141A in the amplification circuit CT1 becomes Lo, and the load impedance of the peak amplifier 142A becomes Hi. Meanwhile, in the amplification circuit CT2, the load impedance of the carrier amplifier 141B becomes Hi, and the load impedance of the peak amplifier 142A becomes Lo.

Therefore, at the time of maximum power in FIG. 15, in each amplification circuit, variations in output power of the carrier amplifier and variations in output power of the peak amplifier offset each other. Additionally, at the time of back-off in FIG. 16, variations in output power of the entire transmission circuit are offset by the increase in output power of the carrier amplifier 141A of the amplification circuit CT1 and the decrease in output power of the peak amplifier 142A.

Additionally, when the load impedance R_{ANT} of the radiating element 600 becomes smaller than the characteristic impedance R_{L} (R_{ANT}<R_{L}), the load impedance of the carrier amplifier 141A in the amplification circuit CT1 becomes Hi, and the load impedance of the peak amplifier 142A becomes Lo. Meanwhile, in the amplification circuit CT2, the load impedance of the carrier amplifier 141B becomes Lo, and the load impedance of the peak amplifier 142A becomes Hi. As a result, at the time of maximum power in FIG. 17 and at the time of back-off in FIG. 18, variations in output power are suppressed for the entire transmission circuit.

As described above, in the antenna module 5 of Embodiment 1, when circularly polarized radio waves are radiated, even if load variations occur in the antenna, variations in output power are offset in each amplification circuit at the time of maximum power, and variations in output power are offset between the amplification circuits at the time of back-off. Accordingly, the robustness of the antenna against load variations can be improved.

The “feed point V1”, “feed point V2”, “feed point H1”, and “feed point H2” in Embodiment 1 correspond to a “first feed point”, a “second feed point”, a “third feed point”, and a “fourth feed point” in the present disclosure, respectively. The “amplification circuit CT1” and “amplification circuit CT2” in Embodiment 1 correspond to a “first amplification circuit” and a “second amplification circuit” in the present disclosure, respectively. Each of the “hybrid coupler 160A” and “hybrid coupler 160B” in Embodiment 1 corresponds to a “first hybrid coupler” in the present disclosure. Each of the “hybrid coupler 130A” and “hybrid coupler 130B” in Embodiment 1 corresponds to a “second hybrid coupler” in the present disclosure.

Each of the “line 161A” and “line 161B” in Embodiment 1 corresponds to a “first line” in the present disclosure. Each of the “line 162A” and “line 162B” in Embodiment 1 corresponds to a “second line” in the present disclosure. Each of the “line 163A” and “line 163B” in Embodiment 1 corresponds to a “third line” in the present disclosure. Each of the “line 164A” and “line 164B” in Embodiment 1 corresponds to a “fourth line” in the present disclosure.

Each of the “line 131A” and “line 131B” in Embodiment 1 corresponds to a “fifth line” in the present disclosure. Each of the “line 132A” and “line 132B” in Embodiment 1 corresponds to a “sixth line” in the present disclosure. Each of the “line 133A” and “line 133B” in Embodiment 1 corresponds to a “seventh line” in the present disclosure. Each of the “line 134A” and “line 134B” in Embodiment 1 corresponds to an “eighth line” in the present disclosure.

Each of the “switch S1A” and “switch S1B” in Embodiment 1 corresponds to a “first switch” in the present disclosure. Each of the “switch S2A and ”switch S2B“ in Embodiment 1 corresponds to a ”second switch“ in the present disclosure. Each of the ”switch S3A and “switch S3B” in Embodiment 1 corresponds to a “third switch” in the present disclosure. Each of the “switch S4A and “switch S4B” in Embodiment 1 corresponds to a “fourth switch” in the present disclosure.

Each of the “phase shift line 171A” and “phase shift line 171B” in Embodiment 1 corresponds to a “first phase shift line” in the present disclosure. Each of the “phase shift line 172A” and “phase shift line 172B” in Embodiment 1 corresponds to a “second phase shift line” in the present disclosure. Each of the “phase shift line 145A” and “phase shift line 145B” in Embodiment 1 corresponds to a “third phase shift line” in the present disclosure.

Each of the “connection node N1A” and “connection node N1B” in Embodiment 1 corresponds to a “first connection node” in the present disclosure. Each of the “connection node N2A” and “connection node N2B” in Embodiment 1 corresponds to a “second connection node” in the present disclosure. Each of the “connection node N3A” and “connection node N3B” in Embodiment 1 corresponds to a “third connection node” in the present disclosure. Each of the “connection node N4A” and “connection node N4B” in Embodiment 1 corresponds to a “fourth connection node” in the present disclosure. Each of the “connection node N5A” and “connection node N5B” in Embodiment 1 corresponds to a “fifth connection node” in the present disclosure. Each of the “connection node N6A” and “connection node N6B” in Embodiment 1 corresponds to a “sixth connection node” in the present disclosure. Each of the “connection node N7A” and “connection node N7B” in Embodiment 1 corresponds to a “seventh connection node” in the present disclosure. Each of the “connection node N8A” and “connection node N8B” in Embodiment 1 corresponds to an “eighth connection node” in the present disclosure.

### Embodiment 2

In Embodiment 1, a transmission circuit corresponding to a dual-polarization-type or circular-polarization-type radiating element has been described. In Embodiment 2, a single-polarization-type transmission circuit configured to radiate radio waves from a radiating element in a single polarization direction will be described.

The number of amplification circuits included in each transmission circuit is not limited to a particular number and may be one or more depending on the number of polarization directions to be supported by the corresponding radiating element. For example, a transmission circuit for a single-polarization radiating element includes one amplification circuit, while a transmission circuit for a dual-polarization or circularly-polarized radiating element includes two amplification circuits. In each case, each amplification circuit includes at least one amplification stage, a first hybrid coupler having first to fourth lines connected in a ring configuration, first to third switches respectively connected between connection nodes of the first hybrid coupler and a ground potential, and first and second phase shift lines respectively connecting output nodes of the first hybrid coupler to corresponding feed points of the radiating element.

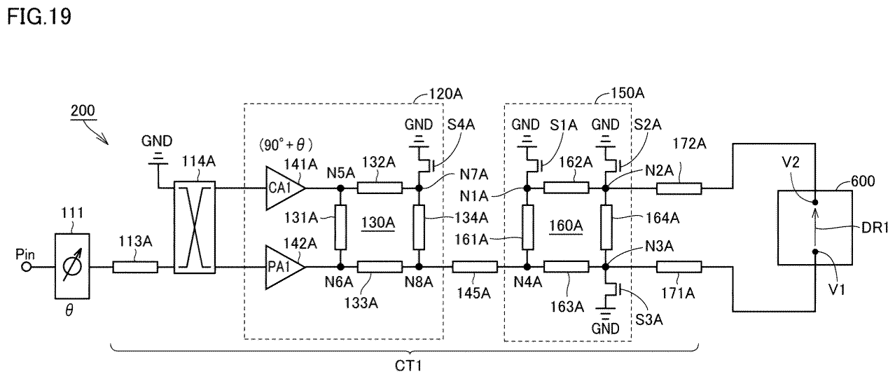

FIG. 19 is a diagram illustrating a configuration of a transmission circuit 200 according to Embodiment 2. Schematically, the transmission circuit 200 has a configuration in which the amplification circuit CT2 and the branch circuit 112 are removed from the transmission circuit 100 of Embodiment 1. The transmission circuit 200 transmits RF signals to the feed points V1 and V2 disposed at positions offset from the center of the radiating element 600 in mutually opposite directions along a direction indicated by arrow DR1 from the center of the radiating element 600. Note that the method of switching feeding to the feed point V1 or V2 is the same as or similar to that described in Embodiment 1.

Again, in the transmission circuit 200 according to Embodiment 2, by switching the feed position to the radiating element 600 using the switches S1A to S3A in the output stage 150A, the phase of radio waves radiated from the radiating element 600 can be changed in the positive and negative directions within the range of the phase shift amount θ of the phase shifter 111. Therefore, by appropriately setting the phase shift amount θ of the phase shifter 111 in each radiating element in the antenna array, the directivity of radio waves radiated from the array antenna can be adjusted.

The signal transmitted to the radiating element 600 does not pass through the switches S1A to S3A used for switching the feed position of each radiating element, and therefore, even when radio waves are radiated using a signal in the sub-terahertz frequency band, a reduction in the gain of radio waves radiated from the radiating element 600 can be suppressed.

### Embodiment 3

In Embodiment 1 and Embodiment 2, a configuration has been described in which the amplification stage includes two amplifiers, a carrier amplifier and a peak amplifier; however, the number of amplifiers included in the amplification stage need not be multiple.

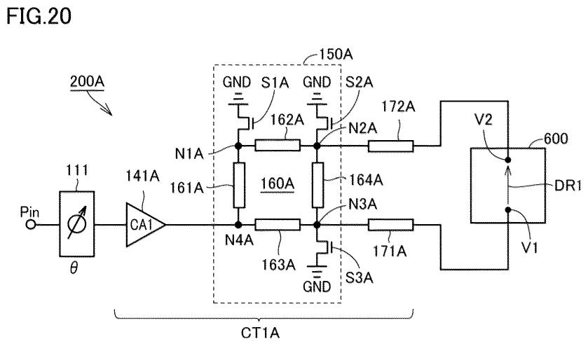

FIG. 20 is a diagram illustrating a configuration of a transmission circuit 200A according to Embodiment 3. The transmission circuit 200A is a single-polarization-type transmission circuit, like the transmission circuit 200 of Embodiment 2, and has one amplification circuit CT1A.

In the amplification circuit CT1A, only the carrier amplifier 141A is provided as an amplification stage. In this case, the efficiency cannot be improved by switching the number of amplifiers, but beamforming can be performed by switching the feed position through switching of the switches S1A to S3A in the output stage 150A. Therefore, even when radio waves are radiated using a signal in the sub-terahertz frequency band, a reduction in the gain of radio waves radiated from the radiating element 600 can be suppressed.

In the configuration of Embodiment 3, the “carrier amplifier 141A” corresponds to an “amplification stage” of the present disclosure.

The embodiments disclosed herein should be regarded illustrative in all respects and not restrictive. The scope of the present invention is defined not by the description of the above embodiments, but by the claims, and it is intended to encompass all modifications within the meaning and scope equivalent to the claims.

### REFERENCE SIGNS LIST

1 communication device; 5 antenna module; 10 transmission module; 20 BBIC; 30 RFIC; 40 power supply circuit; 50 power amplification circuit; 55 bias control circuit; 60 antenna; 100, 100A to 100D, 200, and 200A transmission circuits; 110 phase shift circuit; 111 phase shifter; 112 branch circuit; 113, 113A, 113B, 145, 145A, 145B, 171A, 172A, 171B, and 172B phase shift lines; 114, 114A, 114B, 130A, 130B, 160A, and 160B hybrid couplers; 120, 120A, and 120B amplification stages; 131 to 134, 131A to 134A, 131B to 134B, 161A to 164A, and 161B to 164B lines; 141, 141A, and 141B carrier amplifiers; 142, 142A, and 142B peak amplifiers; 150A and 150B output stages; 410 MPC; 420 power supply selection circuit; 430 digital ET; 600 and 600A to 600D; radiating elements; BS bias signal; CON control signal; CT1, CT2, and CT1A amplification circuits; GND ground potential; H1, H2, V1, and V2 feed points; N1A to N8A, N1B to N8B, and N5 to N8 connection nodes; Pin input signal; Pout_A to Pout_D output signals; S4, S1A to S4A, and S1B to S4B switches; VB battery voltage; and Vcc power supply voltage.

1. An antenna module that radiates a radio wave, comprising:
a plurality of radiating elements having a planar shape; and
a plurality of transmission circuits respectively connected to the plurality of radiating elements,
wherein each of the plurality of radiating elements includes a first feed point and a second feed point disposed at positions offset from a center of the radiating element in mutually opposite directions along a first direction,
wherein each of the plurality of transmission circuits includes:
a phase shift circuit configured to change a phase of a radio frequency (RF) signal; and
an amplification circuit that amplifies a signal from the phase shift circuit and transmit the amplified signal to the first feed point and the second feed point of the corresponding radiating element,
wherein the amplification circuit includes:
an amplification stage configured to amplify a signal from the phase shift circuit;
a first hybrid coupler including a first line, a second line, a third line, and a fourth line connected in a ring configuration;
a first switch connected between a first connection node between the first line and the second line and a ground potential;
a second switch connected between a second connection node between the second line and the fourth line and the ground potential;
a third switch connected between a third connection node between the third line and the fourth line and the ground potential;
a first phase shift line having a first end connected to the third connection node and a second end connected to a first feed point of a corresponding radiating element; and
a second phase shift line having a first end connected to the second connection node and second end connected to a second feed point of the corresponding radiating element, and
wherein a signal from the amplification stage is supplied to a fourth connection node between the first line and the third line.

2. The antenna module according to claim 1, wherein the amplification circuit is configured to amplify a signal from the phase shift circuit and transmit the amplified signal to the first feed point and the second feed point of the corresponding radiating element.

3. The antenna module according to claim 2, wherein:
when supplying an RF signal to the first feed point, the first switch and the second switch are set to a conducting state, and the third switch is set to a non-conducting state; and
when supplying an RF signal to the second feed point, the first switch and the second switch are set to a non-conducting state, and the third switch is set to a conducting state.

4. The antenna module according to claim 2, wherein:
the amplification stage includes:
a carrier amplifier;
a peak amplifier;
a second hybrid coupler including a fifth line, a sixth line, a seventh line, and an eighth line connected in a ring configuration; and
a fourth switch,
an output end of the carrier amplifier is connected to a fifth connection node between the fifth line and the sixth line;
an output end of the peak amplifier is connected to a sixth connection node between the fifth line and the seventh line;
the fourth switch is connected between a seventh connection node between the sixth line and the eighth line and the ground potential;
the amplification circuit further includes a third phase shift line connected between an eighth connection node between the seventh line and the eighth line and the fourth connection node; and
a signal leading an RF signal supplied to the peak amplifier by 90° in phase is supplied to the carrier amplifier.

5. The antenna module according to claim 4, further comprising a bias control circuit configured to dynamically switch an operational state of the amplification stage based on an input power level threshold, the bias control circuit configured:
when power of an RF signal from the phase shift circuit is larger than a predetermined power, set the carrier amplifier and the peak amplifier to an active state; and
when power of an RF signal from the phase shift circuit is smaller than the predetermined power, set the carrier amplifier an active state, and set the peak amplifier to an inactive state.

6. The antenna module according to claim 1,
wherein each of the plurality of radiating elements further includes:
a third feed point and a fourth feed point disposed at positions offset from the center of the radiating element in mutually opposite directions along a second direction intersecting the first direction,
each of the plurality of transmission circuits further includes:
a branch circuit that divides a signal from the phase shift circuit into two paths; and
the amplification circuit includes a first amplification circuit and a second amplification circuit that amplify signals from the branch circuit and transmit the amplified signals to the corresponding radiating element,
wherein the second amplification circuit includes:
an amplification stage configured to amplify a signal from the phase shift circuit;
a first hybrid coupler including a first line, a second line, a third line, and a fourth line connected in a ring configuration;
a first switch connected between the first connection node;
a second switch connected between the second connection node;
a third switch connected between the third connection node;
a first phase shift line having a first end connected to the third connection node; and
a second phase shift line having a first end connected to the second connection node,
wherein, in second amplification circuit, a signal from the amplification stage is supplied to a fourth connection node between the first line and the third line,
wherein a second end of the first phase shift line of the second amplification circuit is connected to the third feed point, and
wherein a second end of the second phase shift line of the second amplification circuit is connected to the fourth feed point.

7. The antenna module according to claim 6, wherein:
the first direction and the second direction are orthogonal; and
a signal supplied from the first amplification circuit to the corresponding radiating element and a signal supplied from the second amplification circuit to the radiating element have a phase difference of 90°.

8. The antenna module according to claim 6, further comprising a bias control circuit configured to select a polarization radiation direction, the bias control circuit configured to:
when radiating a radio wave polarized in the first direction, set the first amplification circuit to an active state, and set the second amplification circuit to an inactive state; and
when radiating a radio wave polarized in the second direction, set the first amplification circuit to an inactive state, and set the second amplification circuit to an active state.

9. The antenna module according to claim 6, wherein:
the amplification stage in each amplification circuit includes:
a carrier amplifier;
a peak amplifier;
a second hybrid coupler including a fifth line, a sixth line, a seventh line, and an eighth line connected in a ring configuration; and
a fourth switch,
in each of the first and second amplification circuits,
an output end of the carrier amplifier is connected to a fifth connection node between the fifth line and the sixth line;
an output end of the peak amplifier is connected to a sixth connection node between the fifth line and the seventh line; and
the fourth switch is connected between a seventh connection node between the sixth line and the eighth line and the ground potential,
each amplification circuit further includes a third phase shift line connected between an eighth connection node between the seventh line and the eighth line and the fourth connection node, and
in each amplification circuit, a signal leading an RF signal supplied to the peak amplifier by 90° in phase is supplied to the carrier amplifier.

10. The antenna module according to claim 9, further comprising a bias control circuit configured to set the fourth switch to a conducting state, wherein the amplification stage in each amplification circuit operates as a Doherty amplifier.

11. The antenna module according to claim 6, wherein the first amplification circuit and the second amplification circuit are configured to simultaneously supply RF signals having a relative phase difference of 90° to the radiating element to selectively emit one of a right-hand circularly polarized wave (RHCP) and a left-hand circularly polarized wave (LHCP).

12. The antenna module according to claim 1, wherein each of the first line, the second line, the third line, the fourth line, the first phase shift line, and the second phase shift line include physical line configuration having an electrical path length equal to substantially one-quarter wavelength of a target center operating frequency of the RF signal.

13. A communication device comprising:
the antenna module according to claim 1; and
a signal processing circuit that processes a radio frequency (RF) signal supplied to the antenna module.
